(19) United States
(12) Patent Application Publication
(10) Pub. No.: US 2014/0305534 A1
(43) Pub. Date: Oct. 16, 2014

(54) Insulation Jacket

(71) Applicant: AEROFLEX USA, Sweetwater, TN (US)

(72) Inventors: Darrell Peil, Rock Hill, SC (US); Sireeporn Khotchapunsoontorn, Sweetwater, TN (US); Brad Steverson, Lenoir City, TN (US); Greg Ertel, Clinton, TN (US)

(73) Assignee: Aeroflex USA, Sweetwater, TN (US)

(21) Appl. No.: 13/860,621

(22) Filed: Apr. 11, 2013

(51) Int. Cl. F16L 59/02

(52) U.S. Cl. CPC F16L 59/029
USPC 138/151

(57) ABSTRACT

An insulating member or tube having an expanded foam core layer surrounded by a layer or jacket of flexible solid rubber, wherein the core layer and the flexible rubber are formed of similar material with similar coefficients of thermal expansion. An insulating member or tube according to the present general inventive concept, by having a core layer and a cover layer with similar coefficients of thermal expansion, provides enhanced insulating capability over competing insulation systems and shows greater resistance to damage to the core layer from externally introduced moisture or other environmental factors.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

The present invention relates generally to insulation tubing and jackets for pipes.

2. Description of the Related Art

Thermal insulation for pipes is known in the art. Insulation tubing is used for pipes and fittings that convey steam, hot materials, condensate, lubricants, cryogenic fluids and cold materials typically used in heating and air conditioning, power facilities, food processing facilities and petrochemical facilities. Whereas cryogenic fluids approach absolute zero, steam for use in power production may range in temperature between 270° F. and 300° F., and can in some cases be much hotter. These temperatures will easily burn an individual should they come in contact with either of these materials or the piping transporting such materials or steam. Thus, insulation tubing is employed in a wide array of industrial applications, such as boilers and petrochemical plants.

The insulation used to cover such pipes or duct work and associated heating and air conditioning units often includes fiberglass or mineral wool, foamed cellular glass or a rigid foam, covered by a jacket of foil or a layer of paper, such as kraft paper.

When such pipes or duct work are in a location exposed to weather, or when they are in other environments where the exterior insulation surface is subject to degradation by moisture or the like, it is advisable to cover the insulation with a facing.

U.S. Pat. No. 5,006,185 by Anthony et al. discloses an insulation and corrosion protection system for a pipe includes a pair of elongated and cross sectionally semi-cylindrical segments of insulating material, and associated method of manufacture and installation. Each section of the insulating segments is made by wrapping a mandrel with an inner sleeve material, applying an elastomeric inner jacket, a layer of insulating material and outer jacket. A hinge is installed beneath the outer jacket for pivotally connecting the two semi-cylindrical portions of the structure. The insulating segment is completely encapsulated within an elastomeric jacket material to seal the insulating member. Before the insulating segment is installed around a pipe an elastomeric sealing material is applied to exposed edges of mating surfaces of the semi-cylindrical portions of the insulation segments. Then the semi-cylindrical portions are positioned around a pipe enclosing it. Bands are secured around the exterior of the insulation segment to secure its separate portions together for curing of the adhesive material. When the material has cured, the bands are removed and any exposed portions of the seam are then covered with an elastomeric sealing material. Adjacent ends of successive insulating segments covering a pipe system are joined with an adhesive and sealed to provide for continuous sealing of the pipe for isolation from the environment surround the pipe.

U.S. Pat. No. 6,953,512 by Cohen et al. discloses a method and material for covering exposed insulation surfaces to protect them from moisture and other environmental factors. The covering typically includes a first, exposed layer of a metal-containing foil, a second layer of a metal-containing foil, a layer of a polymer disposed between the first two layers of foil, a third layer of a metal-containing foil, and a second layer of polymer disposed between the second and third layers of foil. A layer of a pressure sensitive adhesive is applied to one of the exposed layers of foil, and the pressure sensitive adhesive layer is covered with a release liner prior to application. The foil provides the necessary moisture and weather seal, while the polymer provides strength and puncture resistance. The overall thickness of the laminate typically is less than 100 microns

U.S. Patent Application Publication Number 2005/0022892, filed by Babineau et al., and issued as U.S. Pat. No. 6,964,282, discloses a pipe insulation system includes a tubular core of fibrous insulation and a flexible closed cell foam layer overlaying the core and forming an outer surface of the system. The tubular core has a first longitudinal slit extending completely through the wall of the core and a second longitudinal slit in the inner surface of the tubular core, opposite the first slit, that forms a hinge permitting the tubular core to be opened and closed to place the system about a pipe. Preferably, the foam layer has a water vapor permeance rating of 0.02 perms or less and the pipe insulation system includes a seal for sealing the first slit so that an outer surface layer of the sealed system formed by the foam layer and seal has a water vapor permeance rating of 0.02 perms or less.

U.S. Pat. No. 7,624,762 by Cohen et al. discloses a covering for exposed insulation surfaces on fluid conduits for protection from moisture and other environmental factors. The covering typically includes a central fabric layer, such as a woven high density polyethylene fabric surrounded by structures having layers of alternating metal containing foils and puncture resistant polymers. The structures may be bonded to the central fabric layer by a polymer extrusion, such as a low density polyethylene extrusion. An acceptable metal-containing foil may include aluminum foil, and the puncture resistant polymer may be polyester. The resulting covering may be cut with a hand-held implement, such as scissors or a knife or the like, may be formed into desired shapes manually and will retain the desired shape once formed. The overall thickness of the covering typically is no greater than about 350 microns.

Other methods and materials for covering insulation are known in the art.

It is advisable to provide a jacket for the insulation that will prevent or minimize damage to the insulation material from moisture and other environmental factors.

### BRIEF SUMMARY OF THE INVENTION

The present invention in some of its embodiments is directed toward an insulating member or tube having an expanded foam core layer surrounded by a layer or jacket of flexible solid rubber, wherein the core layer and the flexible rubber are formed of similar material with similar coefficients of thermal expansion. An insulating member or tube according to the present general inventive concept, by having a core layer and a jacket layer with similar coefficients of thermal expansion, provides enhanced insulating capability over competing insulation systems and shows greater resistance to damage to the core layer from externally introduced moisture or other environmental factors.

In some embodiments of the present general inventive concept, a tubular insulation member for insulating a pipe includes a core layer fabricated from a closed-cell foam material, said core layer having an inboard face to contact the pipe and an outboard face, said core layer including a split through a thickness of said core layer connecting said inboard face and said outboard face, and a jacket layer to cover said outboard face of said core layer, said jacket layer including an overlap to cover said split in said core layer, said jacket layer being fabricated from a flexible solid rubber membrane.

In some embodiments, a synthetic rubber is used in fabricating said core layer and said synthetic rubber is used in fabricating said jacket layer.

In some embodiments, said core layer includes a closed-cell elastomeric foam.

In some embodiments, said core layer includes ethylene propylene rubber.

In some embodiments, said core layer includes ethylene propylene diene monomer rubber.

In some embodiments, said core layer includes two opposing faces on either side of said split through a thickness of said core layer, and wherein at least one of said two opposing faces includes a self-adhesive seal, whereby when said tubular insulation member is installed around a pipe, said two opposing faces are brought into contact with each other.

In some embodiments, said overlap of said jacket layer to cover said split in said core layer covers an underlying section of said jacket layer, and wherein a pressure-sensitive self-adhesive seal joins said overlap to said underlying section.

In some embodiments of the present general inventive concept, a laminar insulation member for insulating a surface includes a core layer fabricated from a non-fibrous closed-cell foam material, said core layer having an inboard face to contact the surface and an outboard face, and a jacket layer to cover said outboard face of said core layer, said jacket layer being fabricated from a flexible rubber material, wherein said core layer and said jacket layer have similar coefficients of thermal expansion.

In some embodiments, a synthetic rubber is used in fabricating said core layer and said synthetic rubber is used in fabricating said jacket layer.

In some embodiments, said core layer includes a closed-cell elastomeric foam.

In some embodiments, said core layer includes ethylene propylene rubber or ethylene propylene diene monomer rubber.

In some embodiments of the present general inventive concept, a tubular insulation member for insulating a pipe includes a core layer fabricated from a non-fibrous closed-cell elastomeric foam material, said core layer having an inboard face to contact the pipe and an outboard face, said core layer including a split through a thickness of said core layer connecting said inboard face and said outboard face, said core layer including two opposing faces on either side of said split, at least one of said two opposing faces including a self-adhesive seal, whereby when said tubular insulation member is installed around a pipe, said two opposing faces are brought into contact with each other, and a jacket layer to cover said outboard face of said core layer, said jacket layer being fabricated from a flexible solid rubber membrane, said jacket layer including an overlap to cover said split in said core layer, said overlap configured to cover an underlying section of said jacket layer, wherein said core layer and said jacket layer have similar coefficients of thermal expansion.

In some embodiments, the tubular insulation member further includes a pressure-sensitive self-adhesive seal to join said overlap to said underlying section of said jacket layer.

In some embodiments, said core layer includes ethylene propylene rubber.

In some embodiments, said core layer includes ethylene propylene diene monomer rubber.

### BRIEF DESCRIPTION OF THE SEVERAL VIEWS OF THE DRAWINGS

The above-mentioned and additional features of the invention will become more clearly understood from the following detailed description of the invention read together with the drawings in which:

FIG. 1 is a perspective view of a sheet of insulation material according to one example embodiment of the present general inventive concept;

FIG. 2 is a side view of the example embodiment shown in FIG. 1, showing the section view line along which the section view in FIG. 3 is taken;

FIG. 3 is a section view of the example embodiment shown in FIG. 1 and FIG. 2;

FIG. 4 is a perspective view of an insulation tube according to one example embodiment of the present general inventive concept;

FIG. 5 is a side view of the example embodiment shown in FIG. 4, showing the section view line along which the section view in FIG. 6 is taken; and

FIG. 6 is a section view of the example embodiment shown in FIG. 4 and FIG. 5.

### DETAILED DESCRIPTION OF THE INVENTION

The present invention in some of its embodiments is directed toward an insulating member or tube having an expanded foam core layer surrounded by a layer or jacket of flexible solid rubber, wherein the core layer and the flexible rubber are formed of similar material with similar coefficients of thermal expansion. An insulating member or tube according to the present general inventive concept, by having a core layer and a jacket layer with similar coefficients of thermal expansion, provides enhanced insulating capability over competing insulation systems and shows greater resistance to damage to the core layer from externally introduced moisture or other environmental factors.

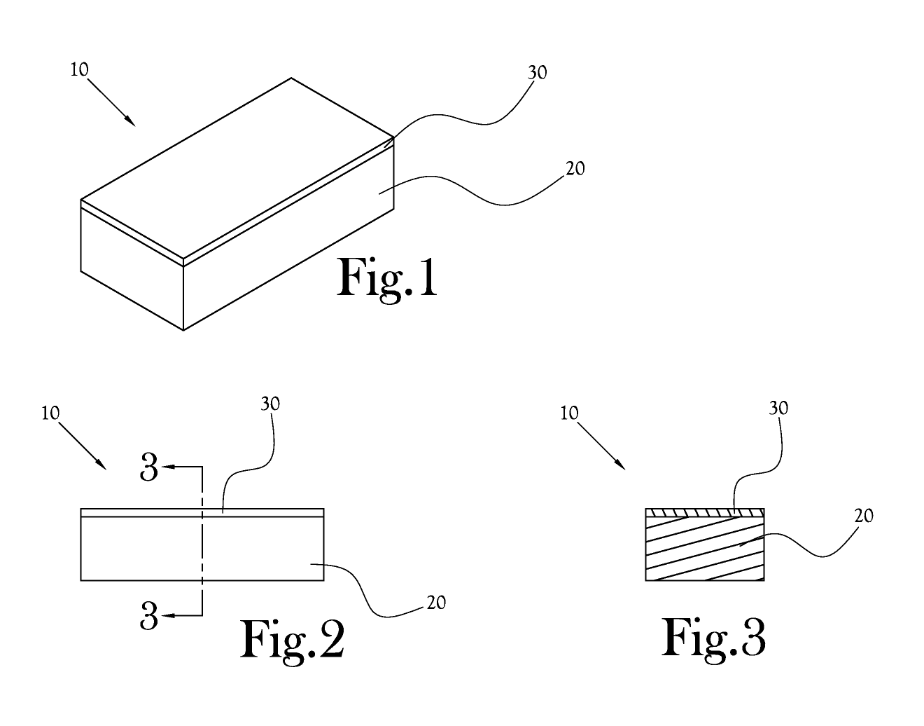

Turning to the Figures, FIG. 1 illustrates one example embodiment of the present general inventive concept. FIG. 2 presents a side view of the example embodiment shown in FIG. 1, with a section line to show where the section view illustrated in FIG. 3 is taken. In the illustrated example embodiment in FIGS. 1-3, a laminar sheet 10 of insulation material includes a core layer 20 and a jacket layer 30. Generally, the core layer 20 is fabricated from a closed-cell foam material, such as a closed-cell ethylene propylene diene monomer (EPDM) foam rubber. Generally, the core layer 20 is fabricated from a non-fibrous material. Generally, the core layer 20 is fabricated from a synthetic rubber. In most embodiments of the present general inventive concept, the jacket layer 30 is fabricated from a flexible solid rubber membrane material.

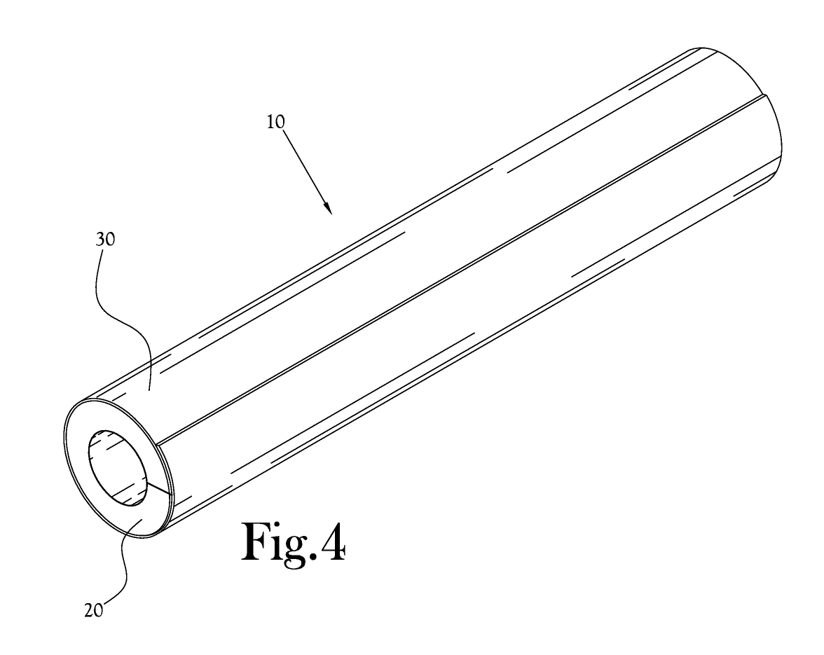

FIG. 4 illustrates one example embodiment of the present general inventive concept, in which the flat insulation material from FIGS. 1-3 has assumed a tubular shape in order to be applied to a pipe or similar structure. In the illustrated example embodiment in FIG. 4, the insulation tube 10 includes a core layer 20 and a jacket layer 30. Generally, the core layer 20 is fabricated from a closed-cell foam material, such as a closed-cell ethylene propylene diene monomer (EPDM) foam rubber. Generally, the core layer 20 is fabricated from a non-fibrous material. Generally, the core layer 20 is fabricated from a synthetic rubber. In most embodiments of the present general inventive concept, the jacket layer 30 is fabricated from a flexible solid rubber membrane material.

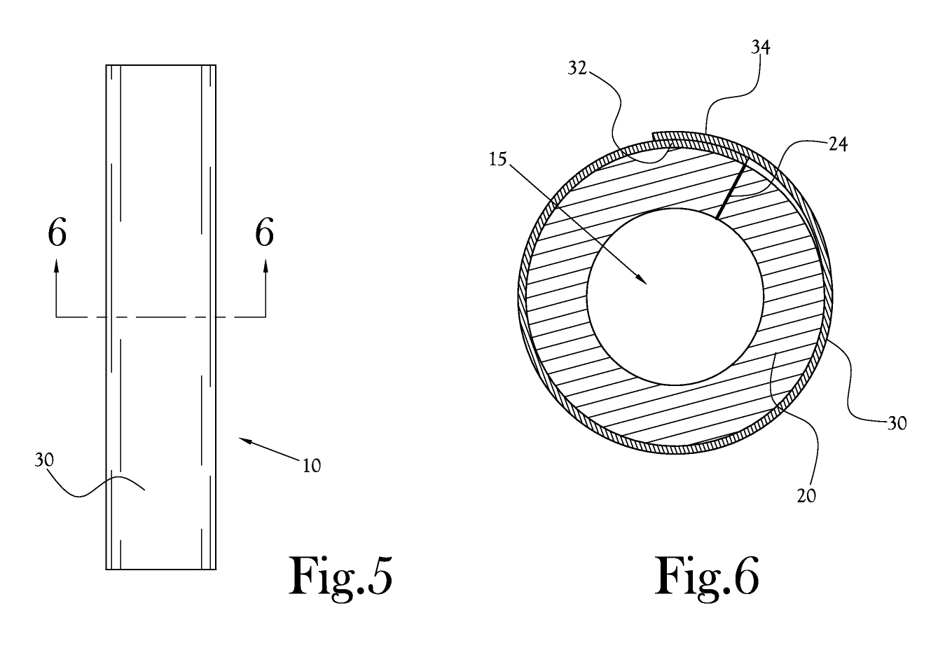

FIG. 5 presents a side view of the example embodiment shown in FIG. 4, with a section line to show where the section view illustrated in FIG. 6 is taken. As shown in the section view in FIG. 6, the core layer 20 of the insulation tube 10 includes a split 24 that extends through the thickness of the core layer 20. This split 24 facilitates bending the insulation tube 10 in order to install the insulation tube 10 around a pipe, with the pipe resultingly occupying the volume 15 surrounded by the core layer 20. The split 24 necessarily creates two opposing faces in the core layer 20, and these two faces are brought together to complete the insulation around the pipe. In some embodiments, at least one face of the core layer 20 includes a pressure-sensitive adhesive seal.

In order to cover the split 24 in the core layer 20 and prevent the split 24 from being a weak point for the failure of insulation or the introduction of moisture or contaminants into the core layer 20, the jacket layer generally includes an overlap 34 that covers the split 24 and overlaps an underlying section 32 of the jacket layer 30. In many embodiments, the overlap 34 or the underlying section 32 includes a layer or coating of adhesive material to join or secure the overlap 34 to the underlying section 32. In many embodiments, either the overlap 34, or the underlying section 32, or both, include a self-adhesive seal to join or secure the overlap 34 to the underlying section 32. The self-adhesive seal to join or secure the overlap 34 to the underlying section 32 helps to enhance the insulating function of the insulation tube and to inhibit the introduction of moisture or contaminants into the core layer 20.

In some embodiments of the present general inventive concept, a tubular insulation member for insulating a pipe includes a core layer fabricated from a closed-cell foam material, said core layer having an inboard face to contact the pipe and an outboard face, said core layer including a split through a thickness of said core layer connecting said inboard face and said outboard face, and a jacket layer to cover said outboard face of said core layer, said jacket layer including an overlap to cover said split in said core layer, said jacket layer being fabricated from a flexible solid rubber membrane. In some embodiments, a synthetic rubber is used in fabricating said core layer and said synthetic rubber is used in fabricating said jacket layer. In some embodiments, said core layer includes a closed-cell elastomeric foam. In some embodiments, said core layer includes ethylene propylene rubber. In some embodiments, said core layer includes EPDM rubber.

In some embodiments of the present general inventive concept, a tubular insulation member for insulating a pipe includes a core layer fabricated from a non-fibrous closed-cell elastomeric foam material, said core layer having an inboard face to contact the pipe and an outboard face, said core layer including a split through a thickness of said core layer connecting said inboard face and said outboard face, said core layer including two opposing faces on either side of said split, at least one of said two opposing faces including a self-adhesive seal, whereby when said tubular insulation member is installed around a pipe, said two opposing faces are brought into contact with each other, and a jacket layer to cover said outboard face of said core layer, said jacket layer being fabricated from a flexible solid rubber membrane, said jacket layer including an overlap to cover said split in said core layer, said overlap configured to cover an underlying section of said jacket layer, wherein said core layer and said jacket layer have similar coefficients of thermal expansion.

In some embodiments of the present general inventive concept, a laminar insulation member for insulating a surface includes a core layer fabricated from a non-fibrous closed-cell foam material, said core layer having an inboard face to contact the surface and an outboard face, and a jacket layer to cover said outboard face of said core layer, said jacket layer being fabricated from a flexible rubber material, wherein said core layer and said jacket layer have similar coefficients of thermal expansion.

Thus, it is seen that in several example embodiments of the present general inventive concept, a tubular insulation member includes two principal components—a core layer and a jacket layer—and each of the two principal components includes a separate seal. In some embodiments, an EPDM closed-cell foam core layer includes a self-adhesive seal, and a flexible solid rubber jacket layer includes a self-adhesive seal. Each self-adhesive seal is independent of the other. This double-sealing provides superior insulation performance and superior protection against the introduction of moisture and other contaminants compared to the prior art.

In some of its many embodiments, the present general inventive concept provides longer lived insulation construction that will not deteriorate under the forces of moisture migration, UV exposure, temperature extremes, impact forces, crushing loads, and other mechanically destructive actions. Unlike some prior art devices and materials, which only suitable for indoor remote application where the insulation will have a low likelihood of seeing significant activity and mild performance needs, insulation tubing according to various embodiments of the present general inventive concept generally is suitable for indoor and outdoor uses and around areas that can expect to see impacts from future activities.

In various embodiments, insulation tubing according to the present general inventive concept generally enhances microbiological growth resistance of the insulation system. This is superior to insulation devices and materials fabricated from fibrous materials, which hold moisture, one key component needed for microbiological growth. Insulation tubing according to the present general inventive concept is also generally superior to NBR-PVC foams, which hold moisture and provide a growth medium for contaminant organisms.

In certain embodiments, the present general inventive concept generally provides a core layer with a non-fibrous, closed-cell EPDM foam rubber, which provides superior properties of resistance to a variety of deleterious forces. The EPDM closed-cell foam makes a highly moisture resistant and weathering resistant insulation system. Many prior art constructs include fiberglass. Fiberglass is an insulator that is highly absorptive and conducts moisture, via wicking, that is destructive to building systems. Fiberglass provides no resistance to UV or water as ice, liquid or vapor. Fiberglass is not resilient to destruction from contact, such as foot traffic, bumps from access equipment, falling objects, and the like. Fiberglass requires a protective finish in almost every application to be a successful product. Various example embodiments of the present general inventive concept show superior performance properties to fiberglass insulation in below-ambient temperature services, such as refrigeration, cryogenic refrigeration, chilled water, and other below-ambient thermal transfer media—glycol, brine, air, halo-carbon refrigerants, water, other gases, liquids, or solids.

In various embodiments, a jacket layer includes a flexible, solid rubber membrane with very low permeability to water. A jacket layer according to the present general inventive concept demonstrates high resilience to the effects of atmospheric humidity, steam, and ice. A jacket layer according to the present general inventive concept demonstrates high resilience to UV and ozone. A jacket layer according to the present general inventive concept demonstrates high resilience to damage from impacts such as foot traffic, bumps from access equipment, falling objects, and the like.

In some embodiments, one or both of the self-adhesive seals includes an adhesive material fabricated from a thermoplastic rubber. In some embodiments, one or both of the self-adhesive seals includes an adhesive material fabricated from a pressure-sensitive polymer. The present general inventive concept is not limited to any particular adhesive material or any single class of adhesive materials, and other adhesive materials may be suitable in some embodiments.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A tubular insulation member for insulating a pipe, comprising:
a core layer fabricated from a closed-cell foam material, said core layer having an inboard face to contact the pipe and an outboard face, said core layer including a split through a thickness of said core layer connecting said inboard face and said outboard face; and
a jacket layer to cover said outboard face of said core layer, said jacket layer including an overlap to cover said split in said core layer, said jacket layer being fabricated from a flexible solid rubber membrane.

2. The tubular insulation member of claim 1 wherein a synthetic rubber is used in fabricating said core layer and said synthetic rubber is used in fabricating said jacket layer.

3. The tubular insulation member of claim 1 wherein said core layer includes a closed-cell elastomeric foam.

4. The tubular insulation member of claim 1 wherein said core layer includes ethylene propylene rubber.

5. The tubular insulation member of claim 1 wherein said core layer includes ethylene propylene diene monomer rubber.

6. The tubular insulation member of claim 1 wherein said core layer includes two opposing faces on either side of said split through a thickness of said core layer, and wherein at least one of said two opposing faces includes a self-adhesive seal, whereby when said tubular insulation member is installed around a pipe, said two opposing faces are brought into contact with each other.

7. The tubular insulation member of claim 1 wherein said overlap of said jacket layer to cover said split in said core layer covers an underlying section of said jacket layer, and wherein a pressure-sensitive self-adhesive seal joins said overlap to said underlying section.

8. A laminar insulation member for insulating a surface, comprising:
a core layer fabricated from a non-fibrous closed-cell foam material, said core layer having an inboard face to contact the surface and an outboard face; and
a jacket layer to cover said outboard face of said core layer, said jacket layer being fabricated from a flexible rubber material;
wherein said core layer and said jacket layer have similar coefficients of thermal expansion.

9. The laminar insulation member of claim 8 wherein a synthetic rubber is used in fabricating said core layer and said synthetic rubber is used in fabricating said jacket layer.

10. The laminar insulation member of claim 8 wherein said core layer includes a closed-cell elastomeric foam.

11. The tubular insulation member of claim 8 wherein said core layer includes ethylene propylene rubber or ethylene propylene diene monomer rubber.

12. A tubular insulation member for insulating a pipe, comprising:
a core layer fabricated from a non-fibrous closed-cell elastomeric foam material, said core layer having an inboard face to contact the pipe and an outboard face, said core layer including a split through a thickness of said core layer connecting said inboard face and said outboard face, said core layer including two opposing faces on either side of said split, at least one of said two opposing faces including a self-adhesive seal, whereby when said tubular insulation member is installed around a pipe, said two opposing faces are brought into contact with each other; and
a jacket layer to cover said outboard face of said core layer, said jacket layer being fabricated from a flexible solid rubber membrane, said jacket layer including an overlap to cover said split in said core layer, said overlap configured to cover an underlying section of said jacket layer;
wherein said core layer and said jacket layer have similar coefficients of thermal expansion.

13. The tubular insulation member of claim 12 further comprising a pressure-sensitive self-adhesive seal to join said overlap to said underlying section of said jacket layer.

14. The tubular insulation member of claim 12 wherein said core layer includes ethylene propylene rubber.

15. The tubular insulation member of claim 12 wherein said core layer includes ethylene propylene diene monomer rubber.
